(19) United States
(12) Patent Application Publication
(10) Pub. No.: US 2026/0215616 A1
(43) Pub. Date: Jul. 30, 2026

(54) A BREWER FOR PREPARING A BEVERAGE

(71) Applicant: Aarke AB, Stockholm (SE)

(72) Inventor: Melker MAGNERIUS, Stockholm (SE)

(73) Assignee: Aarke AB, Stockholm (SE)

(21) Appl. No.: 19/150,425

(22) PCT Filed: Jan. 24, 2024
(86) PCT No.: PCT/EP2024/051672

§ 371 Date: Jul. 23, 2025

(30) Foreign Application Priority Data
Jan. 26, 2023 (SE) 2350074-7

(51) Int. Cl. A47J 31/56; A47J 31/44; A47J 31/52

(52) U.S. Cl. CPC A47J 31/56; A47J 31/4435; A47J 31/525

(57) ABSTRACT

A brewer for preparing a beverage, the brewer comprising a water tank, a water delivery pipe for supplying water from the water tank to a water dispenser, a water detection means for determining a volume of water in the water tank, a heating means for controlling the flow of water. A level of power provided to the heating means is adapted based on an output from the water detection means, being indicative of the volume of water in the water tank. The level of power provided to the heating means controls a flow rate of water through the water delivery pipe to the water dispenser. A method of controlling the flow of water is such a brewer is also provided.

### PRIORITY

This patent application is an International PCT patent application, which claims priority to Swedish patent application no. 2350074-7 with the title “A BREWER FOR PREPARING A BEVERAGE”, filed on Jan. 26, 2023.

### CO-EXISTING RELATED PATENT APPLICATIONS

This PCT patent application is filed concurrently with the patent applications as per below and filed by the same applicant. Details on specific issues in these patent applications are to be considered as incorporated into each one of the related patent applications.

The related PCT patent applications are titled:
A COFFEE BEAN GRINDER
A BREWER WITH A SENSOR, A BREWER KIT AND A METHOD FOR CONTROLLING A BREWER

### TECHNICAL FIELD

The present disclosure generally pertains to a brewer for preparing a beverage and a method of controlling a flow of water in such a brewer.

### BACKGROUND ART

Brewers for preparing beverages such as coffee or tea are well known in the prior art. While the particular steps of coffee preparation vary, it usually involves ground coffee being mixed with hot or cold water (depending on the method of brewing) for a specific time (brew time). The brew time is the amount of time it takes to brew coffee, the start being when water and ground coffee come into contact with one another, and the finish being when the coffee grounds and water cease being in contact. It is known that it is desirable to adapt the brew time for brewing ground coffee to an optimal time. As a small amount of water runs through a filter comprising coffee grounds fast, the brew time may be too short if a maximum brew speed of a brewer is used when brewing a small volume of coffee. A slower pace of the water being added to the filter may be required, when for example just one cup of coffee is to be brewed. In light of this issue, there are brewers in the prior art where a user can press a button to decide if a full coffee pot or just half a pot is to be brewed, where the flow rate of water exiting the brewer is adapted based on this input. There are also brewers that are configured to determine an approximate volume of water in its water tank, and to adapt a flow rate of water from the tank based on this estimated volume.

### SUMMARY OF THE INVENTION

Most brewers automatically brew most of the volume of water contained in the water tank (or, water container or reservoir), since leaving water in the water tank after a brew cycle is complete is not desirable, e.g., due to hygienic reasons. The volume of water added into the water tank may not be known by the user and may not correspond to an exact number of cups of coffee to be brewed. There is a desire to adapt the brew temperature and brew time to the volume of water in the water tank, which corresponds to the volume of beverage which is to be brewed. Regarding coffee, a desired time for brewing a volume of 1.25 litres may for example be 4-6 minutes (using for example around 60 g of ground coffee). A desired temperature of water entering the ground coffee may be 92 to 96° C. This may be done by adapting the temperature of water from the water tank based on the volume of water to be brewed. A rough approximation of the volume in the water tank, for example determined by proximity sensors in the water tank, is not sufficient to provide a brew temperature and brew time that is well adapted to the specific volume of water in the water tank to be brewed.

It is in view of the above mentioned issue and others that the aspects and embodiments of the present invention have been made. The present disclosure recognizes the fact that brewers in the prior art are limited with regards of being able to adapt the brew time and temperature in an automatic, convenient and/or accurate manner. The brewer of the invention is provided with the ability to easily and properly assess the volume of water in its tank and in an efficient manner adapt a water temperature and flow and thereby brew temperature and time based on that volume.

According to a first aspect of the present disclosure, there is provided a brewer for preparing a beverage such as coffee. The brewer comprises a water tank into which water may be manually added by a user. It is also possible that water may be added directly to the tank via a water outlet connected to the tank. The brewer further comprises a water delivery pipe through which water can flow from the water tank to a water dispenser, optionally via a boiler. The water dispenser is configured for dispensing water from the water tank into a container for infusion material (such as coffee grounds of tea), such as a filter holder for a single or multiple use filters. Such a water dispenser may for example be located above an intended location of a such an infusion container. The brewer further comprises a water detection means for determining the volume of water present in the water tank. As used herein, the expression determining the volume of water should be understood in a broad sense. The water detection means may detect a water level or a weight of water, which is indicative of a volume of water in the water tank. Examples of water detections means are discussed in more detail below. The brewer further comprises heating means for controlling the temperature and indirectly the flow of water in the water delivery pipe. The heating means is configured to heat water present in the water tank, or in a boiler, and to thereby indirectly induce a water flow through the water delivery pipe.

The heating of water namely results in a syphon effect where increased pressure, due to the increased temperature of the water, forces water to be pushed through the water delivery pipe and out through a water dispenser, at a certain flow rate which depends on the temperature of the water and thus indirectly on the power supplied to the heating means. The level of heat provided from the heating means is dependent on the level of power provided to the heating means, which is dependent of the voltage provided to the heating means.

It is common in brewers of the prior art that a heating means is combined with a pump. The pump is used to control the flow rate of water from the water tank and thereby the brew time. The heating element used in combination with the pump may have one heat level setting, and usually provides either full power, or no power.

The heating means of the present invention may provide a varying heat output, which is adapted to a desired level by adapting the power into the heating means. By regulating the heating level of the heating means, both the water temperature and water flow with leaves the brewer may be adapted, without the use of a pump.

The possibility to control the flow of water without using a pump results in avoiding some of the problems associated with a pump, such as narrow hoses which are sensitive to dirt and limescale. The components of the brewer of the invention are robust and the expected lifespan of the brewer is thereby long.

In some embodiments however, a pump may be used in addition to the heating means, to provide an additional possibility of fine tuning the water flow.

A temperature sensor may also be present in the brewer, which acts as a complement to the water volume information and provides the possibility of further fine tuning of the level of power supplied to and thereby heat provided from the heating means to achieve a certain temperature and water flow.

The brewer is configured such that a level of power supplied to the heating means is adapted by the brewer, such as by a control unit incorporated in the brewer, in dependence of an output from the water detection means. Output from the water detection means is indicative of a volume of water determined to be present in the water tank. The level of power provided to the heating means is thereby adapted based on the volume of water present in the water tank at the moment of determination. The brewer may, as mentioned, comprise a control unit, which may be adapted to receive output (a signal) from the water detection means, and to based on received output adapt the level of power provided to the heating means.

The adaptation may be based on a known relationship (or, association) of a water volume in the water tank and power supplied to the heating means, to result in a certain temperature and flow of water, a model of which may be programmed into the brewer (or, control unit).

The brewer is thus configured such that the level of power provided to the heating means controls a flow rate of water through the water delivery pipe to the water dispenser. The resulting flow rate of water is however not always proportionate to the power provided to the heating means, i.e. it is not always true that more power provided results in a proportionately higher flow rate of water. An increased power provided to the heating means generally results in the heating means providing more heat to the water, which in turn increases both the temperature and flow rate of the water. After a certain level of power supplied, an increase in power into the heating means (and thereby heat from the heating means) results primarily in increased heat of the water and not increased flow, which may not be desirable. The water may be transformed to steam. For a small volume of water, the heating effect on the water is greater per amount of power provided, and the power level may need to be lower to result in a desired temperature of the water and thereby a desired flow, than compared to heating a larger volume of water to the same desired temperature. The power to be provided from the heating means is therefore adapted according to a model as mentioned above. In other words, based on a determined volume of water (i.e. based on output from the water detection means), the brewer is configured to supply a level of power to the heating means, which is a level that is associated by the brewer (such as by a control unit of the brewer) to result in a certain desired flow rate of water for that volume of water. The desired flow rate for a determined volume of water may be a flow rate that is consistent throughout a brew cycle, or a flow rate that varies according to a brewing profile throughout a brew cycle. The desired flow rate, or brewing profile, may also be updated throughout a brew cycle, during which the determined volume of water in the water tank changes, as will be further discussed below.

The heating means is preferably configured such that the heat applied to the water can be quickly adapted. The heating means may comprise heating element located in a boiler housing, together forming a boiler. The boiler may be located in the water tank, for example in a lower part of the water tank, and be configured to receive water from the water tank. The water delivery pipe may be configured to lead water from the boiler to the water dispenser. The boiler housing may be of a thin-walled stainless steel construction. The boiler housing preferably has a low thermal mass. The heating element may for example be of a substantially cylindrical shape or flat shape.

The boiler may be located outside of the water tank, configured to receive water from the water tank and to deliver heated water into the water delivery pipe. The boiler may be located outside of the water tank, configured to receive water from a separate water source, and to deliver water into the water tank, where the heated water is mixed with water from the water tank, for example by use of a mixer.

The heating means may alternatively be configured such that a heating element is present in the water tank, without being comprised in a boiler housing. The heating element may alternatively, or additionally, be located on the outside of the water tank.

The inlet of the water delivery pipe may be located in a lower part of the water tank, such that water may enter when the volume of water in the tank is low.

The water detection means may be configured to determine the volume of water present in the water tank at initiation of a brew cycle. In this case, the determined volume of water represents a total brew volume of the upcoming brew cycle. The brewer may then be configured to adapt the level of power provided to the heating means based on a brewing program associated with the volume of water determined to be present in the water tank at the initiation of a brew cycle (i.e. based on the total brew volume). The total brew volume may thus be used as an indicator of the desired flow rate of water throughout an upcoming brew cycle. If the total brew volume is large, the desired flow rate may be higher than if the total brew volume is small. The power provided to the heater may be adapted based on the total brew volume such that it is consistent throughout a brew cycle, resulting in for example a high flow rate throughout a whole brew cycle of a large determined total brew volume. The brewer may also be configured to adapt the level of power provided to the heating means such that it varies during a brew cycle according to a brewing program chosen (automatically by the brewer) based on the volume of water determined to be present in the water tank at the initiation of a brew cycle (i.e. total brew volume). It may for example be configured to start with a power level adapted to result in a maximum flow rate of water if the determined total brew volume is large, and stepwise of gradually decrease such that it ends with a lower power level associated with a low flow rate of water. A lower level of power is desirable when the water tank is almost empty, as the water is otherwise is heated without increasing the flow rate, and may transforms to steam.

The water detection means may alternatively, or additionally, be configured to determine the volume of water present in the water tank at a plurality of time points during a brew cycle. The brewer may be configured to adapt a level of power provided to the heating means continuously throughout a brew cycle. If the volume at initiation of a brew cycle is known, the decrease of volume in the tank during the upcoming brew cycle can be approximately anticipated. However, factors such as the temperature of the water added into the water tank may affect the rate of which the volume decreases. Therefore, the water volume may be continuously determined, and the desired power supplied, or chosen brewing program, may be updated throughout a brew cycle. The updated measurements may therefor be used to continuously adapt the process. The plurality of measurements may be used for calculation of the brewing speed, by combining the volume determinations with the time for the measurements, which may be used as input for the brewer (or control unit) to base an adaptation of the power from the heating means on.

The water detection means may comprise at least one position sensor. The position sensor is, or comprises, a type of distance sensor.

A position sensor determines a distance to, or specific position of, an object (which here may be for example a float or the water surface). The distance sensor may be configured for a continuous or stepwise detection of the distance to that object, i.e. the vertical position of that object.

The position sensor may for example be an ultrasonic sensor, an infrared distance sensor, a pressure sensor or a laser distance sensor. The position sensor may be a linear position sensor. The position sensor may be a magnetic field sensor that determines the distance from an object comprising a magnet by measuring a magnetic field surrounding the object. The position sensor may be an analogue/digital input sensor that provides an analogue/digital output proportional to the distance between the sensor and the object. It may be an inductive analogue sensor that gives out a current or voltage signal which is proportional to the distance between the sensor and the object.

The position sensor may be a capacitive sensor which determines if water is present or not at a certain vertical level. In this case, several such sensors are preferably provided along the vertical extension of the water tank, and the locations of the sensors which determine water to be present at its vertical level and those that do not are used to determine an estimated water level.

The water detection means may comprise a float and at least one position sensor configured to detect the vertical position of the float. A float to be used in combination with a magnetic sensor comprises at least one magnet, such as a neodymium magnet.

The water detection means may comprise at least one position sensor configured to detect the vertical position of the surface of water.

The brewer is configured to determine the water volume in the water tank based on output from the water detective means being indicative of such a detected vertical position of a float or water surface.

The brewer may comprise a control unit, which is configured to receive an output from the position sensor, said output being indicative of the water level, for example of a detected vertical position of a float or water surface. The control unit may be configured to associate a detected vertical position of the float or surface with a water level and thereby water volume of a certain water tank, and use that information to select an associated heat level to be provided from the heating means (i.e. level of power to be provided to the heating means).

The output may for example be dependent on a voltage of the position sensor being induced as a result of a magnetic field surrounding a magnet of a float. In other words, the position sensor may detect a magnetic field surrounding a magnet in the float, and as a result of this provide a voltage which acts as a signal to the control unit, representing a position of the float and thereby a water volume.

The control unit is configured to adapt the level of power provided to the heating means based on output from the water detection means. It may use the received output to calculate an intermediate value representing a water level or water volume and adapt the level of power provided based on that intermediate value. Alternatively, the output received from the position sensor is directly associated with a level of power to be provided from the heating means.

As a position sensor may detect the position of an object, and not just the presence of an object, one position sensor may be enough to determine the volume of water in the water tank. The position sensor needs to be configured to detect the position of the float or water surface at all or at least most possible water levels, along the vertical extension of the water tank, if the volume of water is to be determined in a manner sufficient for the purpose of the invention. One position sensor may be sufficient, if the shape of the water tank is such that the vertical extension is short.

A position sensor may be configured to measure the position of an object such as a float in a manner such that the detection made by the sensor is the same for two different positions of the float. These two positions are interpreted as the same position. For example, a position sensor may be configured such that it is only able to determine the distance to the object, and not the angular orientation of the object in relation to the position sensor. The position sensor may not be able to distinguish between the float being in a position of a certain distance below the position sensor and the float being in a position of a certain distance above the position sensor. The position sensor may not be able to distinguish between the float being in two different positions when the float is near the position sensor.

This may apply for example to magnetic sensors with a float comprising a magnet. Due to the shape of a magnetic field surrounding a magnet, a magnetic sensor may not be able to distinguish between the field surrounding the float being a certain position from the field surrounding the float being in another position. There are two possible positions of the float resulting in the same measurement result of a detected magnetic field by the position sensor. These two positions may be at the same distance from the magnetic sensor but on different sides (above and below) the sensor, respectively, or at two positions on the same side, near the position sensor, depending on the type of magnetic field.

Due to this issue, one position sensor may need to be located in a vertical end of the water tank, such that the detected position of the float may only be interpreted as below the sensor if the sensor is located in the top of the tank or as above the sensor if the sensor is located in the bottom of the tank. This decreases the length of the vertical extension this sensor may cover. A water tank with a long vertical extension may require more than one position sensor to be able to correctly determine the position of the float at any vertical location of the water tank. The number of position sensors which are needed is determined depending on the shape and size of the tank, as well as the sensing area of the position sensors used.

In cases where output from just one position sensor is not be enough to determine the position of the float, as discussed above, the combination of the output from two position sensors may be used, the combined output from which can only indicate one specific float position. Each possible combination of output from two position sensors are associated by the brewer (or control unit) to a determined water level (i.e. water volume). More than two, such as three, four or five, position sensors may be positioned along the vertical extension of the water tank.

Along the vertical extension of the water tank, position sensors should be placed such that the sensing areas of two position sensor overlap at all possible water levels or for all possible positions of the float, least in the areas where a top or bottom sensor is not able to detect the float.

The position sensors are configured to send an output indicating this position to the brewer, which is then configured to determine a water volume present in the tank based on the output, and to adapt the power from the heating means based on the determined water volume.

The brewer may for example comprise a control unit which is adapted to receive output (a signal) from each position sensor that detects the float, and to based on combination of received signals determine a water volume represented by that combination of signals, and to based on the water volume control the power provided to the heating means and indirectly the water flow (the intermediate step of determining a water volume may not be necessary).

The control unit may be further configured to receive another type of signal, which is based on a user input, indicating a desired strength of the coffee to be brewed. This may be used to further adapt the power provided to the heating means and thereby the brew time.

The brewer may further comprise a stop sensor. The purpose of the stop sensor is to alert the brewer when the water tank is empty or almost empty, in other words when the water level is close to or at the bottom of the tank and a float is near or at its lowest possible vertical position. The stop sensor may be a located at a lower end of the water tank and configured to detect a presence of the float within a proximity area of the stop sensor, upon which detection the brewer is configured to turn off the heating means. The stop sensor may be a proximity sensor. The stop sensor may alternatively be a distance sensor coupled with a control unit acting as a switch, turning off the heating means when the position of the float is determined to be within a certain range of the stop sensor. The effect of such a setup is similar to that of a proximity sensor. The stop sensor may be of the same type as the position sensor(s), but having a separate connection to an off-switch for the heating means.

The brewer may comprise a Hall effect sensor (Hall sensor), i.e. the stop sensor or at least one of the position sensors may be a Hall effect sensor. This is suitable when the float comprises a magnet. A Hall effect sensor is a magnetic sensor that responds proportionally to magnetic flux density. It uses the phenomenon of the Hall effect to output a voltage proportional to the strength of the magnetic field detected. The device can be used for accurate position sensing of objects comprising magnets.

The brewer may comprise a position sensor configured to detect a vertical position of the float when the water tank is filled with water to at least 50% of its maximum capacity, and a position sensor configured to detect a vertical position of the float when the water tank is filled with water to less than 50% of its maximum capacity.

The brewer may comprise at least one position sensor, such as 1-6 position sensors, configured to detect the distance to the float in a continuous manner when the float moves along a vertical extension of the water tank. The water volume in the water tank can thereby be determined with an accuracy of for example less than 125 ml. The accuracy may, depending on the type and number of sensors used, be as low as for example 50 ml, 30 ml, 15 ml, 10 ml or 5 ml. As the volume of water in the water tank is not added in an amount corresponding to a certain number of cups, it is highly relevant to be able to measure the volume with an accuracy of a higher level than for example around 125 ml.

The brewer may comprise at least two position sensors, such as two, three, four, five or six position sensors, wherein any given possible location of the float is within the sensing area (the area within which the position sensor detects the float) of the top sensor, of the lowest sensor, and/or of at least two sensors.

When the float is in its highest vertical position, it may only be detectable by the top sensor. At the top, or as the float reaches a lower position, the second highest position sensor detects the position of the float, while the float is still detected by the top sensor.

As the float moves down along the vertical extension of the water tank, the position sensors are located such that at any location, at least two position sensors are able to detect the float. After passing the second lowest sensor, the float may again reach a location where it is only detectable by one position sensor, the lowest position sensor.

In other words, the sensing areas of the position sensors overlap, such that at any given location, except for at the top and bottom of the water tank (within the sensing areas of the top or lowest position sensor), at least two sensing areas are overlapping.

The sensing areas may only cover the vertical extension of the water tank at a certain horizontal location of the water tank, where the float is expected to be.

The brewer may comprise a float track arranged along the vertical extension of the water tank along which the float is movable. The horizontal movement may be limited by the float track. The float track may be configured such that the float may be movable along at least 40%, 50%, 60%, 70% or 80%, such as at least 90%, of the vertical extension of the water tank. The float may in other embodiments not be constricted by a float track, but still be movable along at least 40%, 50%, 60%, 70% or 80% of the vertical extension of the tank. The float track may comprise a float track housing which limits the movement of the float. It may be coupled to an arm restricting its movements.

The brewer may comprise a receptacle heater for heating a beverage receptacle placed on the receptacle heater. The brewer may be configured to adapt a heating level of the receptacle heater based on an output from the water detection means, wherein the output indicating a volume of water in the water tank, in a similar way as the power provided to the heating means is adapted. The heating level may be adapted with regards to a total brew volume determined at the initiation of a brew cycle, or with regards to a water volume determined during a brew cycle, or by the time that has passed since a brew cycle has ended. For example, a high total brew volume determined at the initiation of a brew cycle may be combined with a high highest temperature of the receptacle heater being applied at least at some point before, during and/or after the brew cycle, while a low total brew volume determined at the initiation of a brew cycle may be combined with a lower highest temperature. The temperature of the receptacle heater may be relatively low at the beginning of a brew cycle, as the volume in the receptacle is not yet high, to increase over time as the receptacle is filled, and after that decrease over time, as the receptacle is likely to be gradually emptied. Decreasing the temperature over time also aims to avoid burning beverage in the receptacle, even if it is not being emptied. The receptacle heater may be in the form of a heating plate.

The brewer may be configured to be manually provided with water into the water tank. The brewer may comprise a water dispenser located in a position suitable for dispensing water from the water delivery pipe into a filter holder. The brewer may be a filter-coffee brewer for household use.

In a second aspect of the invention, a method of controlling a flow rate of water in a brewer for producing a beverage is provided, wherein the brewer comprises a water tank, a water delivery pipe for supplying water from the water tank to a water dispenser, a water detection means for determining the volume of water present in the water tank, and a heating means for controlling the flow of water from the water tank to the water dispenser. The method is suitable to be implemented with a brewer such as the brewer disclosed herein. The method comprises determining the volume of water present in the tank, and adapting a level of power provided to the heating means based on an output from the water detection means, wherein the output indicates a volume of water present in the water tank.

A flow rate of water through the water delivery pipe is adapted as a consequence of adapting the level of power provided to the heating means, as the heating means heat the water in the tank and causes a syphon effect where water is caused to flow through the water delivery pipe and out of the water dispenser.

The water detection means may comprise a float and at least one position sensors, and the method comprise the further steps of detecting, performed by at least one position sensor, a vertical position of a float, and determining, by means of the brewer, such as by means of a control unit of the brewer, the volume of water in the water tank based on output from at least one position sensor, said output being indicative of the vertical position of the float.

### BRIEF DESCRIPTION OF THE DRAWINGS

The present invention will be described further below by way of example and with reference to the enclosed drawings, in which:

FIG. 1 shows a brewer comprising water detection means comprising at least one sensor and a float,

FIG. 2 shows a brewer comprising a heating means comprising a heating element in a boiler housing,

FIG. 3 shows a sensor board comprising position sensors and a stop sensor,

FIG. 4 shows the sensor board of FIG. 3 fastened on a sensor board support as well as a float,

FIG. 5 shows the parts of FIG. 4 covered by a float track housing,

FIG. 6 shows a float with a float housing comprising a float housing body and a float housing lid,

FIG. 7 shows the float of FIG. 6 without the float housing body, such that a magnet within the float is seen,

FIG. 8 is an exploded view of a water tank housing, a float track, a float, and a sensor board is shown,

FIG. 9 shows an float of an alternative embodiment to the embodiment of FIGS. 6-7, comprising two magnets in a float housing.

### DETAILED DESCRIPTION OF EMBODIMENTS

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements throughout the description.

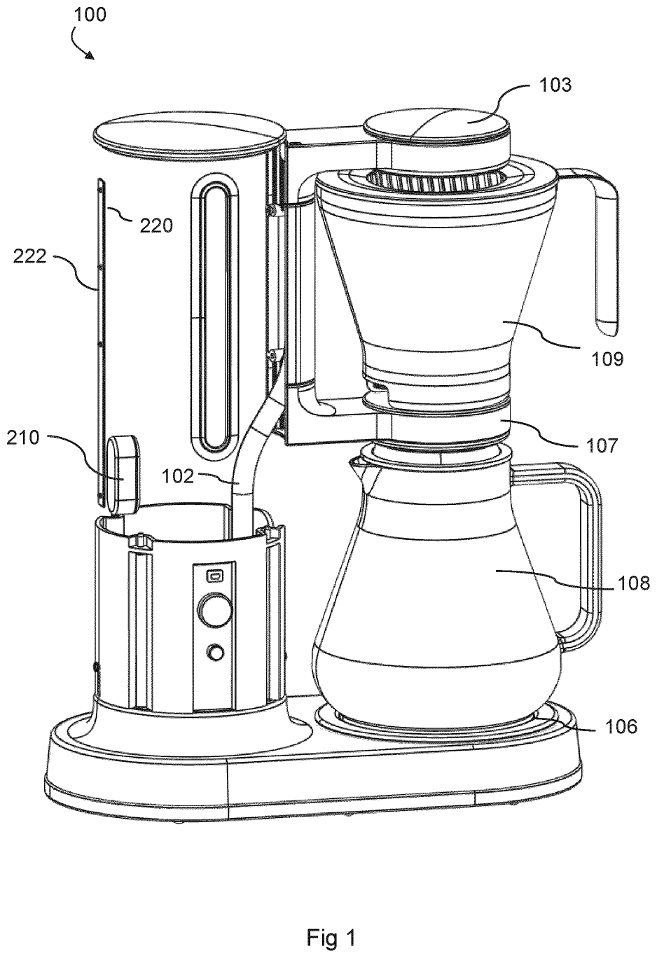

FIG. 1 shows an embodiment of the brewer 100 according to the invention. The present brewer 100 is adapted for preparing a beverage and comprises water tank 101 which is not shown in the figure for ease of illustration, a water delivery pipe 102 for supplying water from the water tank 101 to a water dispenser 103. The brewer 100 of FIG. 1 further comprises a water detection means 200 for determining a volume of water present in the water tank 101. The water detection means 200 in this embodiment comprises a float 210 and at least one position sensor 220 fastened to a sensor board 222. The brewer 100 further comprises a heating means 104 for controlling the flow of water in the water delivery pipe 102. The heating means 104 is not shown in the figure, as it is hidden behind a cover part of the brewer covering an area beneath the water tank 101, but may for example be located in or beneath the water tank 101.

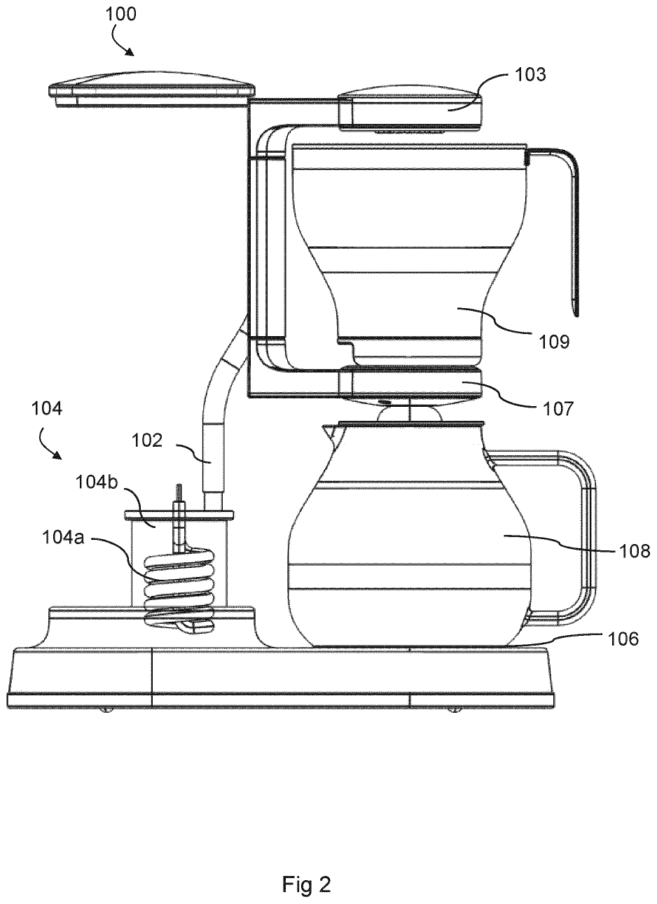

The brewer 100 is configured such that a level of power provided to the heating means 104 is adapted in dependence of an output from the water detection means 200. The output is indicative of the volume of water present in the water tank 101. The level of power provided to the heating means 104 in turn controls a flow rate of water through the water delivery pipe 102 to the water dispenser 103. It does so by heating the water in the water tank, which causes water to be pushed through the water delivery pipe 102. The flow rate is dependent on the level of power provided to the heating means 104, although not in a proportionate manner. An increase in power does not always result in a proportionate increase in flow rate. This depends on factors including the volume of water to be heated. For this reason, the level of power supplied is adapted to the volume of water indicated to be present in the water tank 101 by the water detection means 200 and to the desired flow rate of water from the water tank 101, which may depend on the volume of water in the water tank 101 optionally in combination with a user input representing a desired strength of coffee. The brewer in FIG. 2 is equipped with a beverage receptacle 108 and a filter holder 109 supported by a filter holder support 107.

FIG. 2 shows an embodiment of a brewer 100 according to the invention. In FIG. 2, a heating means 104 is shown to comprise a heating element 104a located in a boiler housing 104b, together forming a boiler. The boiler housing 104b is located in a lower part of the water tank 101 and configured such that water enters the boiler housing 104b from the water tank 101, is heated by the heating element 104a, and then enters into the water delivery pipe 102, which has its inlet located to receive water from the boiler. The location in a low part of the water tank 101 is suitable as the volume of water in the water tank 101 may be low.

The heating means 104 provide heat to the water in the water tank, which as a result of the heat flows into and through the water delivery pipe 102 and out through the water dispenser 103. The level of heat provided from the heating element 104 is dependent, although not always proportionately, to the power provided to the heating means 104. The brewer 100 is configured to adapt the level of power provided to the heating means 104 in order to adapt the flow rate of water through the water delivery pipe 102. The brewer may comprise a control unit configured to receive input from the water detection means, and based on said input control the power provided to the heating means 104. The control unit may be programmed to be able to associate an output of the water detections means 200 (which may comprise information from one or more position sensors) with a level of power to be provided from the heating means 104, said level of power being predetermined to be adequate to provide a desired temperature and flow rate for that output (the output representing a water volume in the water tank 101). The desired flow rate may vary during a brew cycle, and the output may be associated with a brewing program to be initiated, instead of a consistent power level to be provided, chosen based on the volume of water determined to be present in the water tank 101 at the initiation of a brew cycle.

The water detection means 200 of the brewer 100 of FIG. 1 or 2 may be configured to determine the volume of water present in the water tank 101 at an initiation of a brew cycle, i.e. before power is provided from the heating means 104, where the determined volume of water represents a total brew volume of that brew cycle. The brewer 100 may be configured to adapt the level of power provided to the heating means 104 based this total brew volume, in a consistent or varying program based manner.

The water detection means 200 of the brewer 100 of FIG. 1 or 2 may be configured to determine the volume of water present in the water tank 101 at a plurality of time points during a brew cycle. The brewer 100, or a control unit in the brewer, may be configured to adapt the level of power provided to the heating means 104 continuously throughout a brew cycle, based on updated output from the water detection means 200.

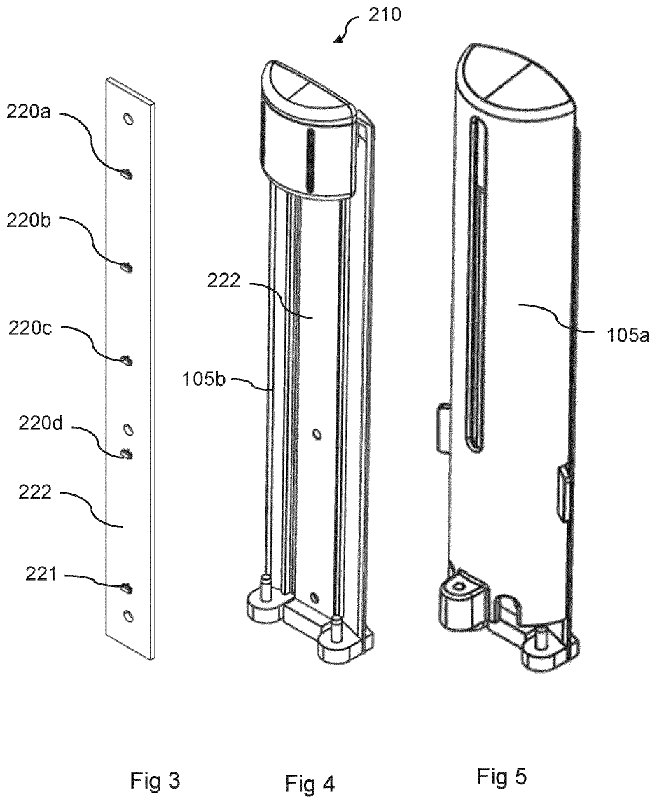

FIG. 3 shows a sensor board 222 comprising a plurality of position sensors 220 and a stop sensor 221 positioned in the lower end of the sensor board 222. As can be seen, there are four position sensors 220a-d in the illustrated example. Position sensor 220a is the top position sensor and 220d is the lowest position sensor.

The water detection means 200 of the brewer 100 of the invention may comprise a float 210 and at least one position sensor 220, as illustrated by FIGS. 1, 3-5 and 8. The position sensors 220 are each configured to detect a vertical position of the float 210. The brewer 100, or a control unit of the brewer, is configured to receive output the output indicating a detected vertical position from at least one such sensor and based on this output determine the water level or volume in the water tank 101.

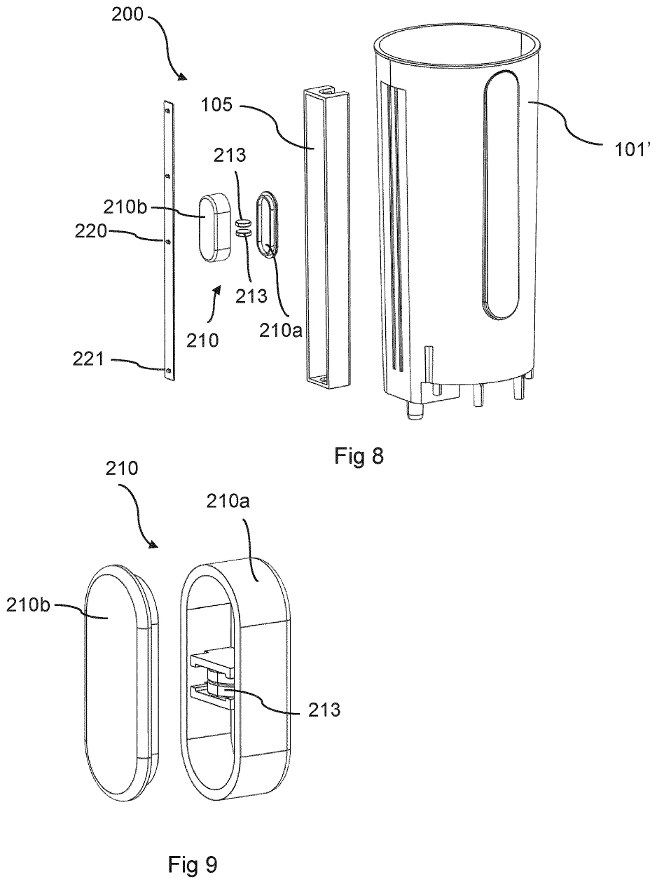

The water detection means 200 may in some embodiments comprise two or more position sensors 220. Each position sensor 220 is configured to detect a vertical position of the float 210. The position sensors are spread along the vertical extension of the water tank 101, as seen in FIGS. 1 and 8, such that the sensing areas of the position sensors cover the extension. The brewer 100, or a control unit of the brewer, is configured to determine the water level in the water tank 101 based on output from either the top position sensor 220a, or at least two sensors 220a-d or the lowest sensor 220d, said output being indicative of a detected vertical position of the float 210.

Due to the fact that a sensor may not be able to distinguish between two different positions of the float when the position sensor is located such that the float may be either above or below the sensor, there should be a position sensor located by the maximum level of the float or the minimum level of the float. If the sensing area of the position sensor covers the full vertical extension of the water tank 101, one sensor may be sufficient to detect the position of the float 200 and thereby determine the volume of water present in the tank 101, for all possible water volumes. If the sensing area does not cover the whole tank, more than one position sensor is preferably incorporated.

In one embodiment, seen in FIG. 3, four position sensors 220a-d are spread vertically over a sensor board 222 to be fastened in the water tank 101. FIG. 3 further shows a stop sensor 221 located at a lower end of the sensor board 222, intended to be placed near the bottom of the water tank 101. The stop sensor 221 is configured to detect a presence of the float 210 within a proximity area of the stop sensor 221, and the brewer is configured to turn off the heating means 104 upon such detection of the presence of the float. The stop sensor may be added as an extra security measure. Alternatively, a position sensor 220 may be used to determine when the water tank 101 is empty or almost empty.

The number of and positions of the position sensors are preferably adapted such that the vertical position of the float 201 can be detected by at least one position sensor when the water tank 101 is filled with water to anywhere between 10% to 90% of its maximum capacity.

The brewer 100 may comprise at least one position sensor 220, where the position sensor(s) 220 is/are configured to detect the position of the float 210 in a continuous manner along the vertical extension of the water tank 101, such that the water volume in the water tank 101 can be determined, for any volume, with an accuracy of less than 125 ml, or preferably less than 100, 75, 50, 25, 10 or 5 ml. The accuracy is thereby much higher than that which may be determined by aid of proximity sensors spread along the water tank 101, which sensors can only determine if a float is present within an area or not, and decide an approximate volume. The accuracy of the adapted flow rate in relation to the water volume is high, as no approximation to a number of cups to be brewed is made.

FIG. 4 shows the sensor board 222 fastened on a sensor board support 105b as well as a float 210. The sensor board support 105b may be fastened to the outside of the housing of a water tank 101. The purpose of the sensor board support 105b is for fastening of the sensor board 222. The sensor board can be fastened in alternative ways, such as by adhesive means or fastening means such as screws. The sensors 220 may alternatively be fastened without the use of a sensor board 222.

FIG. 5 shows the parts of FIG. 4 being covered by a float track housing 105a, which limits the movement of the float 201 to a substantially vertical movement along the water tank 101.

The float 210 may be movable along at least 80% of the vertical extension of the water tank 101, as illustrated for example by the indicated location of the float track 105 in relation to the water tank housing 101′ in FIG. 8. A float track 105, along which the float 210 is movable, may be arranged along the vertical extension of the water tank 101.

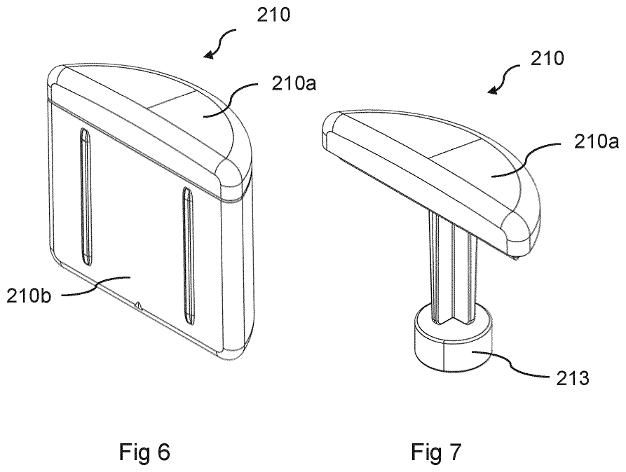

A position sensor 220 may be a magnetic position sensor. The brewer 100 according to any of claims 6-9 comprising a Hall effect sensor. The float 210 to be used in combination with such sensors 220 is suitable to comprises at least one magnet 213, for example a neodymium magnet. An embodiment of such a float 210 is shown in FIGS. 6-7 and another embodiment of such a float 210 is shown in FIGS. 8-9.

FIG. 6 shows a float 210 with a float housing comprising a float housing body 210b and a float housing lid 210a. FIG. 7 shows the float of FIG. 6 without the float housing body 210b, such that a magnet 213 within the float 210 is seen.

FIG. 8 is an exploded view of a brewer 100 showing the housing of the water tank 101, a float track 105, a float 200 comprising a float housing body 210b and a float housing lid 210a, and a sensor board comprising a position sensor 220 and a stop sensor 221.

FIG. 9 shows the float 210 of FIG. 8 assembled, with two magnets 213 in the float housing body 210b.

The brewer may in some embodiments further comprise a receptacle heater 106 for heating a beverage receptacle 108 placed on the receptacle heater 106. Such a receptacle heater 106 is shown in FIGS. 1 and 2, in form of a heating plate under the beverage receptacle 108. The brewer 100 may be configured to adapt the heating level of the receptacle heater 106 based on an output from the water detection means 220, in a way that is similar to the herein described adaptation of the water flow. The heating level being adapted in relation to a determined volume of water in the water tank results in the heating level indirectly being adapted in relation to an expected volume of beverage in the beverage receptacle. For example, a determined total brew volume can be used to anticipate the upcoming increase of volume in the beverage receptacle 108. The heating level may be varied over time, for example according to a heating profile automatically selected based on a determined total brew volume. For example, the heat provided by the receptacle heater 106 at the start of a brew cycle may be off or low, then to be increased, followed by being decreased, and/or then to be turned off completely, all according to a time schedule of that heating profile.

The brewers 100 of the embodiments depicted in FIGS. 1 and 2 are configured to be manually provided with water into the water tank 101. They further comprise a water dispenser 103 located in a position suitable for dispensing water from the water delivery pipe 102 into a filter holder 109.

A method of controlling a flow rate of water in a brewer 100 for producing a beverage, for example the above-described brewer 100, may comprise the water detection means 200 detecting the volume of water present in the tank 101, and the brewer 100 or a control unit of the brewer adapting a level of power provided to the heating means 104 based on an output from the water detection means 200. The flow rate of water through the water delivery pipe 102 is dependent of the level of power provided to the heating means 104. The output indicates a volume of water present in the water tank 101. The result is a flow rate of water which is adapted based on a determined water volume of the water tank 101.

The water detection means 200 used in the method may comprise a float 210 and at least two position sensors 220, wherein the at least one position sensor 220 detects a vertical position of the float 210, and the brewer 100 or a control unit of the brewer determines the volume of water in the water tank 101 or determines a value which corresponds to the volume based on the output from at least one position sensor 220, said output comprising information indicative of a detected vertical position of the float 210.

The brewer 100 may, as disclosed above, comprise an undepicted control unit that is in communicative connection with a position sensor 220 and that may control the power provided to the heating means 104 and/or the receptacle heater 106.

Modifications and other variants of the described aspects and embodiments will come to mind to one skilled in the art having benefit of the teachings presented in the foregoing description and associated drawings. Therefore, it is to be understood that the embodiments are not limited to the specific example aspects and embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims.

As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A brewer for preparing a beverage, the brewer comprising:
a water tank,
a water delivery pipe for supplying water from the water tank to a water dispenser,
a water detection means for determining a volume of water present in the water tank,
a heating means for controlling the flow of water in the water delivery pipe, wherein
the brewer is configured such that a level of power supplied to the heating means is adapted in dependence of an output from the water detection means, said output being indicative of the volume of water determined to be present in the water tank, in that
the brewer is configured such that the level of power supplied to the heating means controls a flow rate of water through the water delivery pipe to the water dispenser, and in that
the water detection means comprises a float and at least two position sensors, wherein each position sensor is configured to detect a vertical position of the float, and wherein the brewer is configured to determine the water level in the water tank, and thereby the volume of water in the tank, based on output from each position sensor, said output being indicative of a detected vertical position of the float.

2. The brewer according to claim 1, wherein the heating means comprises a heating element located in a boiler housing located beneath the water tank and below an inlet of the water delivery pipe.

3. The brewer according to claim 1, wherein the water detection means is configured to determine the volume of water present in the water tank at an initiation of a brew cycle, said volume of water representing a total brew volume of that brew cycle, and wherein the brewer is configured to adapt a level of power provided to the heating means based on the volume of water determined to be present in the water tank at the initiation of a brew cycle.

4. The brewer according to claim 3, wherein the brewer is configured to adapt the level of power provided to the heating means such that it varies during a brew cycle according to a brewing program chosen based on the volume of water determined to be present in the water tank at the initiation of a brew cycle.

5. The brewer according to claim 1, wherein the water detection means is configured to determine the volume of water present in the water tank at a plurality of time points during a brew cycle, and wherein the brewer is configured to adapt the level of power provided to the heating means continuously throughout a brew cycle.

6. The brewer according to claim 1, wherein the brewer comprises at least one magnetic position sensor and the float comprises at least one magnet, such as a neodymium magnet.

7. The brewer according to claim 1 comprising a stop sensor located at a lower end of the water tank, configured to detect a presence of the float within a proximity area of the stop sensor, and wherein the brewer is configured to turn off the heating means upon such detection of the presence of the float.

8. The brewer according to claim 1 comprising a Hall effect sensor.

9. The brewer according to claim 1 comprising at least one position sensor configured to detect a vertical position of the float when the water tank is filled with water to at least 80% of its maximum capacity, and at least one position sensor configured to detect a vertical position of the float when the water tank is filled with water to less than 30% of its maximum capacity.

10. The brewer according to claim 1, comprising at least one position sensor configured to detect the distance to the float in a continuous manner when the float moves along a vertical extension of the water tank, such that the water volume in the water tank can be determined with an accuracy of less than 125 ml.

11. The brewer according to claim 1, wherein the float is movable along at least 80% of the vertical extension of the water tank.

12. The brewer according to claim 1, comprising a float track arranged along the vertical extension of the water tank along which the float is movable.

13. The brewer according to claim 1, comprising a receptacle heater for heating a beverage receptacle placed on the receptacle heater, wherein the brewer is configured to adapt a heating level of the receptacle heater based on an output from the water detection means, said output indicating a volume of water in the water tank.

14. The brewer according to claim 1, wherein the brewer is configured to be manually provided with water into the water tank and wherein the brewer comprises a water dispenser located in a position suitable for dispensing water from the water delivery pipe into a filter holder.

15. A method of controlling a flow rate of water in a brewer for producing a beverage, wherein the brewer comprises a water tank, a water delivery pipe for supplying water from the water tank to a water dispenser, a water detection means for determining the volume of water present in the water tank, said water detection means comprising a float and at least two position sensors, and a heating means for controlling the flow of water from the water tank to the water dispenser, the method comprising:
detecting, by at least one position sensor, a vertical position of the float,
determining, by the water detection means, the volume of water present in the tank based on output from at least one position sensor, said output being indicative of the vertical position of the float.
adapting, by the brewer, a level of power provided to the heating means based on an output from the water detection means, said output indicating a volume of water present in the water tank, whereby a flow rate of water through the water delivery pipe is adapted in dependence of the level of power provided to the heating means.
